(19) United States
(12) Patent Application Publication
(10) Pub. No.: US 2002/0080338 A1
(43) Pub. Date: Jun. 27, 2002

(54) Projection exposure apparatus

(75) Inventor: Tetsuo Taniguchi, Ageo-shi (JP)

Correspondence Address: OLIFF & BERRIDGE, PLC, P.O. Box 19928, Alexandria, VA, 22320, US

(73) Assignee: Nikon Corporation

(21) Appl. No.: 10/013,374

(22) Filed: Dec. 13, 2001

Related U.S. Application Data
(63) Continuation of application No. 09/686,065, filed on Oct. 11, 2000.
Application No. 09/686,065 is a continuation of application No. 09/344,248, filed on Jun. 25, 1999, now abandoned.
Application No. 09/344,248 is a continuation of application No. 09/166,142, filed on Oct. 2, 1998, now abandoned.
Application No. 09/166,142 is a continuation of application No. 08/631,047, filed on Apr. 12, 1996, now abandoned.
Application No. 08/631,047 is a continuation-in-part of application No. 08/411,306, filed on Mar. 27, 1995.

(30) Foreign Application Priority Data
Apr. 13, 1995 (JP) 87853/1995
Mar. 29, 1994 (JP) 6-058932
Jun. 16, 1994 (JP) 6-134007

(51) Int. Cl. G03B 27/54

(52) U.S. Cl. 355/67; 355/52; 355/55; 355/53

(57) ABSTRACT

A pattern of a reticle is projected onto a wafer through an optical projection system by a scanning exposure method. A distortion corrector is disposed between the reticle and the optical projection system. The distortion corrector comprises a first optical wedge which has an upper surface facing the reticle and perpendicular to the optical axis of the optical projection system and a slant lower surface, and a second optical wedge which has a lower surface perpendicular to the optical axis and an upper surface slanting in parallel to the lower surface of the first optical wedge. The two optical wedges are moved in opposite directions along a scanning direction perpendicular to the optical axis by an optical member control system, thereby changing the optical path length for illuminating light in the distortion corrector, and thus continuously correcting distortion.

### BACKGROUND OF THE INVENTION

The present invention relates to a projection exposure apparatus used, for example, to produce semiconductor integrated circuits, liquid crystal devices, etc. by photolithography processes. More particularly, the present invention relates to the correction of image-formation characteristics such as distortion of an image projected by an optical projection system.

Projection exposure apparatuses of the type described above have heretofore been demanded to maintain image-formation characteristics of a projected image, which is formed by an optical projection system, with high accuracy at all times in order to project a fine-line pattern of a reticle (or a photomask or the like) onto a wafer (or a glass plate or the like), which is coated with a photoresist, at high resolution, or to project a reticle pattern over a pattern already formed on the wafer with high overlay accuracy. The image-formation characteristics may be gradually changed due to various causes such as variations in environmental conditions of the optical projection system, including the ambient atmospheric pressure, temperature, etc.; variation in configuration of the reticle or the optical projection system due to the absorption of illuminating light; variation of the reticle pattern due to switching of reticle illumination methods or use of a phase shift mask or the like; and so forth. It should be noted that the term “switching of reticle illumination methods” as used herein means switching from an ordinary illumination method to, for example, an annular zone illumination method or a modified light source illumination method.

Under these circumstances, the conventional practice is to measure an amount of change of environmental conditions, to predict an amount of change of image-formation characteristics from the result of the measurement, and to correct the image-formation characteristics so that the predicted amount of change is canceled. In the conventional image-formation characteristic correction, objects to be corrected are mainly the defocus of the projected image and the projection magnification. These two items of image-formation characteristics have heretofore been corrected as follows: Regarding the defocus of the projected image, the desired value of the focus position is corrected in a mechanism (autofocus mechanism) for maintaining the distance between the optical projection system and the wafer at a constant value. Regarding the correction of the projection magnification, there have been proposed a technique wherein a space between lenses in the optical projection system is hermetically sealed, and the pressure in the lens space is varied, and another technique wherein a part of lenses constituting the optical projection system are moved in the direction of the optical axis.

In this regard, as the patterns of semiconductor integrated circuits become increasingly finer, not only the defocus and the projection magnification but also variation of isotropic distortion (pincushion distortion or barrel distortion) have been becoming unignorable in recent years. There have been proposed various devices for correcting the isotropic distortion: a mechanism in which the reticle is moved in the direction of the optical axis of the optical projection system; a mechanism in which a part of lenses constituting the optical projection system are moved in the optical axis direction; a mechanism in which the wavelength of light emitted from a light source (e.g., a laser light source) for exposure is varied; a mechanism in which a space between lenses in the optical projection system is hermetically sealed, and the pressure in the lens space is varied; and so forth.

The above-described conventional isotropic distortion correcting devices suffer from problems as stated below. First, unlike the projection magnification, the isotropic distortion is aberration of higher order. Therefore, if correction is made by using the mechanism in which a part of lenses constituting the optical projection system are moved in the optical axis direction, or the mechanism in which the wavelength of light emitted from a light source for exposure is varied, or the mechanism in which the pressure in a hermetically sealed space between predetermined lenses in the optical projection system is varied, among the above-described conventional correcting devices, other aberrations change; therefore, it is impossible to correct only the isotropic distortion independently of other aberrations. If it is intended to correct the newly produced aberrations by another mechanism, the entire correcting mechanism becomes complicated. If it is intended to correct the isotropic distortion while holding the variation of the other aberrations in an allowable range, the amount of aberration which can be corrected becomes small. Thus, the desired correction cannot be attained. In contrast, the technique wherein the reticle is moved in the optical axis direction makes it possible to correct only the isotropic distortion without affecting other aberrations.

Thus, the technique in which the reticle is moved in the optical axis direction is convenient for the correction of isotropic distortion.

However, there has recently been an increasing demand for a wider field area to be exposed with the given image-formation characteristics maintained. To comply with the demand, scanning exposure type projection exposure apparatuses (projection exposure apparatuses of the slit-scan type or the step-and-scan type) have been proposed in which exposure is carried out with the reticle and the wafer scanned relative to the optical projection system. This type of projection exposure apparatus has the advantages that it is possible to use the largest diameter of the effective exposure field of the optical projection system by illuminating the reticle with slit-shaped light, and that the scanning enables the exposure field to be enlarged in the scanning direction without being restricted by the optical system. Further, since only a part of the optical projection system is used, the required accuracies for illuminance uniformity, distortion, etc. can be readily obtained. In the scanning exposure type projection exposure apparatus, however, the reticle and the wafer must be scanned synchronously with high accuracy. Therefore, a stage for the reticle is demanded to have high rigidity. It is desirable in order to enhance the rigidity of the reticle stage that the system should be free from a mechanism for moving the reticle in the optical axis direction. In a one-shot exposure type projection exposure apparatus such as a stepper also, it is desirable that the reticle stage should have high rigidity.

Further, since the reticle is directly driven, an error in the drive of the reticle directly affects the image-formation characteristics or the registration accuracy. That is, if the reticle tilts from a plane perpendicular to the optical axis, the image plane is inclined, and distortion changes. If the reticle transversely shifts, the positional relationship between the alignment sensor and the image deviates from the desired condition, causing a registration error to occur. Alternatively, it becomes necessary in order to prevent the occurrence of such errors to employ an exceedingly high level of control technique or position measuring technique for the reticle drive system, resulting in a rise of the production cost.

In view of the above-described circumstances, an object of the present invention is to provide a projection exposure apparatus capable of correcting isotropic distortion without producing an adverse effect on other aberrations and without moving the reticle in the direction of the optical axis.

### SUMMARY OF THE INVENTION

The projection exposure apparatus according to the present invention includes, an illumination light source for exposure, an optical projection system for projecting an image of a pattern for transfer formed on a mask onto a photosensitive substrate by illuminating light from the illumination light source, a light-transmitting plate with a variable thickness which is disposed between the mask and the substrate, and an optical path length changing device for changing an optical path length for the illuminating light by changing the thickness of the light-transmitting plate, wherein distortion of the image of the pattern projected on the substrate is adjusted by changing the thickness of the light-transmitting plate through the optical path length changing device.

In this case, the arrangement may be such that the light-transmitting plate comprises a single optical wedge with a continuously variable thickness, and the optical path length changing device is a moving device which causes the optical wedge to move in a direction in which the thickness of the optical wedge is variable. The arrangement may also be such that the light-transmitting plate comprises a plurality of optical wedges each having a continuously variable thickness, and the optical path length changing device is a moving device which causes the optical wedges to move relative to each other.

The plurality of optical wedges may include a fixed optical wedge and a movable optical wedge. The fixed optical wedge may have an irregularly corrugated polished surface for correcting anisotropic irregular distortion. The fixed optical wedge may be a lens having a curvature on one side thereof.

The arrangement may also be such that the light-transmitting plate comprises a plurality of light-transmitting flat plates having different thicknesses, and the optical path length changing device is a changing device for changing the plurality of light-transmitting flat plates from one to another.

The plurality of optical wedges may be moved relative to each other with a gap between mutually opposing surfaces thereof kept constant.

The projection exposure apparatus may further include a system whereby the plurality of optical wedges are moved relative to each other in parallel to an optical axis, and a lateral displacement of the projected image due to the movement is corrected.

The projection exposure apparatus may be a scanning type projection exposure apparatus in which the mask is scanned in a predetermined scanning direction, and the substrate is scanned in a direction corresponding to the predetermined scanning direction in synchronism with the scanning of the mask, thereby sequentially transferring the pattern of the mask onto the substrate by exposure, wherein the optical path length changing device causes the optical wedge or the optical wedges to move in the predetermined scanning direction.

According to the projection exposure apparatus of the present invention, arranged as described above, the optical path length between the mask and the optical projection system is varied by changing the thickness of the light-transmitting plate with a variable thickness, thereby enabling isotropic distortion to be corrected without moving either the mask or the optical projection system. Further, since distortion is corrected by only the light-transmitting plate disposed between the mask and the photosensitive substrate without any optical member, e.g., a lens, interposed therebetween, the system is free from aberrations which would otherwise be produced by such an optical member. Accordingly, the use of the light-transmitting plate enables isotropic distortion (pincushion distortion or barrel distortion) to be changed independently of other aberrations.

In a case where the light-transmitting plate comprises one or a plurality of optical wedges and the optical path length changing device is a device for moving the optical wedge or wedges, the optical path length can be continuously changed by moving the optical wedge or wedges in a direction in which the thickness thereof is continuously variable by the moving device. Accordingly, distortion can be continuously corrected. If the optical wedge or wedges are designed so that the thickness varies gently, the optical path length can be strictly controlled without the need of strictly positioning the optical members.

Particularly, in a case where the upper side of the light-transmitting plate closest to the reticle and the lower side of the light-transmitting plate closest to the substrate are planes approximately parallel to each other, three-dimensional positioning of the light-transmitting plates requires no very high accuracy. Accordingly, the positioning accuracy for the light-transmitting plates is much less stringent than that required in a case where the mask or the optical projection system itself is driven.

In a case where the projection exposure apparatus is a scanning type projection exposure apparatus and the optical wedge or wedges are moved in the scanning direction, the travel distance of the optical wedge or wedges is minimized because the apparatus uses a slit-shaped illumination area which is short in the scanning direction. Further, since the mask or the optical projection system itself need not be physically driven to correct isotropic distortion, the present invention is particularly effective for a scanning type projection exposure apparatus which requires high rigidity as a whole.

In a case where the light-transmitting plate comprises a plurality of light-transmitting plates and the optical path length changing device is a device for changing the light-transmitting plates from one to another, the system arrangement is advantageously simplified, although distortion correction is made discontinuously. In this case also, if the light-transmitting plates to be changed from one to another are plane-parallel plates, the positioning accuracy for the light-transmitting plates need not be particularly high, as described above. Accordingly, the system arrangement can be further simplified.

### BRIEF DESCRIPTION OF THE DRAWINGS

FIG. 1 is a block diagram partly containing a cutaway view, schematically- showing one embodiment of the projection exposure apparatus according to the present invention.

FIG. 2 illustrates a turret for changing illumination conditions used in the projection exposure apparatus shown in FIG. 1.

FIG. 3 is a perspective view showing the way in which a reticle and a wafer are scanned in the projection exposure apparatus shown in FIG. 1.

FIGS. 4(a) and 4(b) schematically illustrate the isotropic distortion correcting principle in the embodiment shown in FIG. 1.

FIG. 5 shows the condition of distortion corresponding to each of the conditions shown in FIGS. 4(a) and 4(b).

FIG. 6 shows the condition of distortion (including a magnification error) when an isotropic distortion correcting mechanism is set in an intermediate position between the positions shown in FIGS. 4(a) and 4(b).

FIG. 7(a) shows marks formed on a reticle to measure distortion.

FIG. 7(b) shows marks formed on a pattern plate, which is separate from a reticle, to measure distortion.

FIGS. 8(a) and 8(b) show a first modification of a distortion corrector used in the embodiment of the present invention.

FIG. 9 shows a second modification of a distortion corrector used in the embodiment of the present invention.

FIG. 10 shows a third modification of a distortion corrector used in the embodiment of the present invention.

### DETAILED DESCRIPTION OF PREFERRED EMBODIMENTS

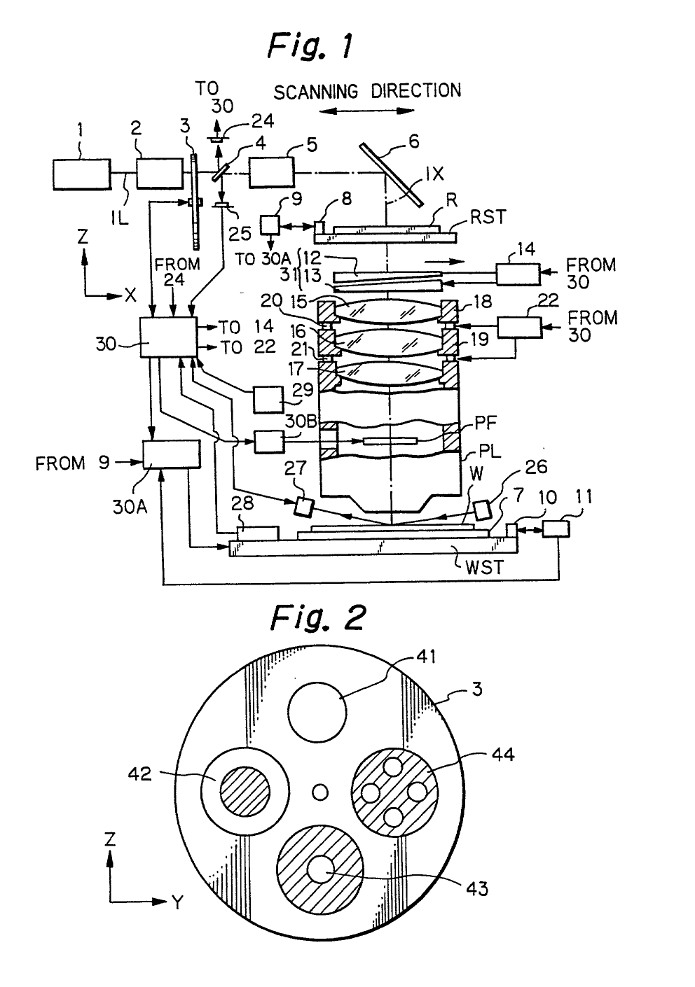

One embodiment of the projection exposure apparatus according to the present invention will be described below with reference to FIGS. 1 to 7. The present invention is applicable to either of one-shot exposure type (e.g., step-and-repeat projection aligner) and scanning exposure type (e.g., step-and-scan projection aligner) projection exposure apparatuses. In the following description, the present invention is applied to a scanning exposure type projection exposure apparatus, in which the advantageous effects of the present invention are exhibited even more favorably. However, the application of the present invention to a one-shot exposure type projection exposure apparatus gives almost the same favorable results. It should be noted that, in FIG. 1, a Z-axis is taken in a direction parallel to an optical axis IX of an optical projection system PL, and an X-axis is taken in a direction parallel to the plane of FIG. 1 in a plane perpendicular to the optical axis IX. Further, a Y-axis is taken in a direction perpendicular to the plane of FIG. 1.

FIG. 1 schematically shows the arrangement of a projection exposure apparatus according to this embodiment. In FIG. 1, a light source 1 may be an excimer laser light source, e.g., a KrF excimer laser, or an ArF excimer laser, or a harmonic generator, e.g., a copper vapor laser, or a YAG laser, or a super-high pressure mercury-vapor lamp. When the light source 1 is a super-high pressure mercury-vapor lamp, illuminating light IL comprising ultraviolet emission line (g-line, i-line, etc.) is emitted from the light source 1. The illuminating light IL enters an illuminance uniformizing optical system 2, which comprises a collimator lens, a fly-eye lens, etc. After converted into a bundle of light rays having an approximately uniform illuminance distribution in the optical system 2, the illuminating light IL is led to a turret 3 for changing illumination conditions.

FIG. 2 is a front view of the turret 3, which is shown in FIG. 1. In FIG. 2, the turret 3 has four stops 41 to 44 disposed thereon at intervals of 90° so that the light intensity distribution on the Fourier transform plane (pupil plane) of an optical projection system PL can be changed by changing the stops 41 to 44 from one to another through rotation of the turret 3. This is one of techniques for improving the resolution of the optical projection system. According to a pattern to be transferred by exposure, the most suitable stop is selected from among the four stops 41 to 44.

In the example shown in FIG. 2, the circular stop 41 is an ordinary aperture stop (a stop), and the annular stop 42 is a stop for annular zone illumination. The relatively small circular stop 43 is a stop for narrowing the angle of the ray bundle to realize an illumination condition which is equivalent to that in a case where the coherence factor (a value) is small (e.g., the a value is of the order of 0.1 to 0.4) in an ordinary illumination system. The stop 44, which comprises four eccentric circular openings (or having cross-shaped light-blocking portions), is a stop for multi-oblique illumination (modified light source), which is generally used to transfer a line-and-space pattern at a high resolution by exposure. The turret 3 is used with an optimum stop selected according to the pattern of a reticle R used.

Illuminating light IL passing through a predetermined stop of the turret 3 reaches a beam splitter 4 having photoelectric sensors 24 and 25 at both sides thereof. The beam splitter 4 transmits almost all ray bundles but reflects some ray bundles. A ray bundle passing through the turret 3 and reflected by the beam splitter 4 enters the photoelectric sensor 24. Light coming from a wafer W and reflected by the beam splitter 4 enters the photoelectric sensor 25. Signals detected by the photoelectric sensors 24 and 25 are used for calculation of aberration variation of the optical projection system PL, as described later. Illuminating light IL further passes through an illumination optical system 5, which comprises a relay lens, a field stop, a condenser lens, etc., and is then reflected by a dichroic mirror 6 to illuminate a reticle R having a semiconductor circuit pattern or the like written thereon. The reticle R is held on a reticle stage RST by vacuum. The reticle stage RST is adapted to position the reticle R by moving slightly in two-dimensions along a plane (XY-plane) perpendicular to an optical axis IX (coincident with the optical axis of the optical projection system PL) which is bent by the dichroic mirror 6 in the optical illumination system 5.

The reticle stage RST is also movable in a direction X (scanning direction) at a predetermined scanning speed in by a reticle drive unit (not shown) which comprises a linear motor, etc. The reticle stage RST has a travel stroke which is sufficient for the whole surface of the reticle R to cross at least the optical axis IL of the illumination optical system 5. A moving mirror 8 is fixed on an end portion of the reticle stage RST to reflect a laser beam from an interferometer 9. Thus, the position in the scanning direction of the reticle stage RST is constantly detected by the interferometer 9 at a resolution of the order of 0.01 μm, for example. Information concerning the position of the reticle stage RST from the interferometer 9 is sent to a stage control system 30A. The stage control system 30A drives the reticle stage RST through the reticle drive unit (not shown) on the basis of the reticle stage position information. The position of the reticle R can be measured with a sufficiently high accuracy simply by measuring the position of the moving mirror 8 with the interferometer 9 because the initial position of the reticle stage RST is determined so that the reticle R is placed in a predetermined reference position with high accuracy by a reticle alignment system (not shown).

Illuminating light IL passing through the reticle R enters a distortion corrector 31 which comprises a pair of optical wedges 12 and 13 having the same configuration. The optical wedges 12 and 13 are each formed with substantially the same size as that of the reticle R so that all the illuminating light IL passing through the reticle R can pass through a light-transmitting area of the distortion corrector 31. The optical wedges 12 and 13, which constitute the distortion corrector 31, are each driven in the scanning direction (direction X) to thereby correct distortion. The distortion corrector 31 will be explained later in detail.

Illuminating light IL passing through the distortion corrector 31 enters an optical projection system PL which is telecentric on both sides. Thus, an image of the circuit pattern on the reticle R is formed by the optical projection system PL on a wafer W, which has a photoresist (photo-sensitive material) coated on the surface thereof, as a projected image demagnified at the projection magnification β(e.g., ⅕ or ¼).

An optical filter which blocks a ray bundle at and near the optical axis IX, that is, a center-shielding type pupil filter PF, is removably installed at or near the pupil plane (Fourier transform plane with respect to the reticle R) of the optical projection system PL. The pupil filter PF is particularly effective in improving resolution and the depth of focus in an exposure process for transferring a contact hole pattern. A main control system 30 controls insertion and withdrawal of the pupil filter PF through a filter loading-unloading device 30B. The optical projection system PL in this embodiment is further provided with mechanisms (15 to 22) for correcting image-formation characteristics, which will be described later.

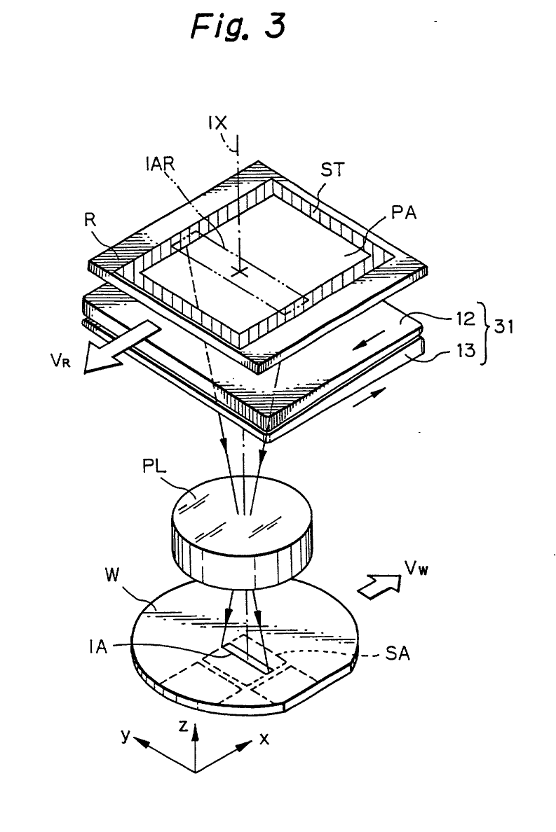

FIG. 3 is a perspective view showing the way in which the reticle R and the wafer W, shown in FIG. 1, are scanned. Although in FIG. 3 the optical projection system PL is shown as if it were non-telecentric for the sake of convenience, it is, actually, telecentric on both sides (or at least on the wafer side). In the projection exposure apparatus according to this embodiment, as shown in FIG. 3, the reticle R is illuminated with an illumination area IAR in the shape of a rectangle (slit shape) which has a longitudinal axis in a direction (direction Y) perpendicular to the scanning direction (direction X) of the reticle R. During exposure, the reticle R is scanned in the direction −X (or +X) at speed V_{R}. A pattern in the illumination area IAR (the center of which is approximately coincident with the optical axis IX) is projected on the wafer W through the optical projection system PL. Thus, a slit-shaped projection area IA is formed on the wafer W.

The wafer W is in inverted image-formation relationship to the reticle R. Therefore, the wafer W is scanned synchronously with the reticle R at speed VW in the direction +X (or −X) opposite to the scanning direction of the reticle R. In this way, the pattern of the reticle R is sequentially transferred onto the whole surface of a shot area SA on the wafer W by exposure. The scanning speed ratio (V_{W}/V_{R}) is accurately coincident with the projection magnification β of the optical projection system PL, so that the pattern in the pattern area PA on the reticle R is accurately transferred onto the shot area SA on the wafer W as a demagnified pattern image. The longitudinal width of the illumination area IAR is set wider than the pattern area PA on the reticle R and narrower than the maximum width of the shielding area ST so that the entire pattern area PA is illuminated by scanning the reticle R.

Returning to the description of FIG. 1, the wafer W is held on a wafer holder 7 by vacuum. The wafer holder 7 is retained on a wafer stage WST. The wafer holder 7 is tiltable in any direction and also slightly movable in the direction of the optical axis IX (direction Z) with respect to the best focus plane of the optical projection system PL by a drive unit (not shown). The wafer holder 7 is also rotatable about the optical axis IX. The wafer stage WST is arranged to be movable not only in the above-mentioned scanning direction (direction X) but also in a direction (direction Y) perpendicular to the scanning direction so that any desired one of a plurality of shot areas can be reached as occasion demands. Thus, the wafer stage WST performs a step-and-scan operation in which it repeats a scanning exposure operation for each shot area on the wafer W and an operation of moving in the direction Y as far as an exposure start position for the subsequence shot area. A wafer stage drive unit (not shown) comprising a motor, etc. drives the wafer stage WST to move in the directions X and Y. A moving mirror 10 is fixed on an end portion of the wafer stage WST to reflect a laser beam from an interferometer 11. Thus, the position in the XY-plane of the wafer stage WST is constantly detected by the interferometer 11 at a resolution of the order of 0.01 μm, for example. Positional information (or speed information) concerning the wafer stage WST is sent to the stage control system 30A. The stage control system 30A controls the wafer stage drive unit on the basis of the positional information (or speed information).

In addition, the apparatus shown in FIG. 1 is provided with an oblique incidence wafer position detecting system (focus detecting system). The wafer position detecting system comprises an optical illumination system 26 which supplies a bundle of image-forming rays for forming a pinhole image or a slit image on the exposure surface of the wafer W at an oblique angle to the optical axis IX, and a light-receiving optical system 27 which receives a reflected ray bundle from the exposure surface of the wafer W through a slit. The wafer position detecting system is secured to a support member (not shown) for supporting the optical projection system PL. The arrangement of the wafer position detecting system is disclosed in more detail, for example, in U.S. Pat. No. 4,650,983. The wafer position detecting system is used to detect a positional deviation in the direction Z of the wafer exposure surface from the best focus plane of the optical projection system PL and to drive the wafer holder 7 in the direction Z so that the wafer W and the optical projection system PL keep a predetermined distance therebetween. Wafer position information from the wafer position detecting system is sent to the stage control system 30A through the main control system 30. The stage control system 30A drives the wafer holder 7 in the direction Z on the basis of the wafer position information.

It should be noted that in this embodiment the angle of a plane-parallel glass (not shown) provided in the light-receiving optical system 27 has previously been adjusted so that the best focus plane (image-forming plane) of the optical projection system PL is a zero standard, and thus the wafer position detecting system is calibrated. It is also possible to detect an inclination of a predetermined area on the wafer W with respect to the image-forming plane by using a horizontal position detecting system in which a bundle of parallel rays is applied to a surface under detection, and an amount of lateral displacement of a convergence point of light reflected from the surface is detected, as disclosed, for example, in U.S. Pat. No. 4,558,949, or by arranging a wafer position detecting system such that it is possible to detect focus positions at a plurality of arbitrary positions in the image field of the optical projection system PL (e.g., a plurality of slit images are projected in the image field). In this case, leveling is effected by adjusting the inclination angle of the wafer holder 7.

Further, a photoelectric sensor 28 is installed on the wafer stage WST, and an environmental sensor 29 is provided in the vicinity of the optical projection system PL to measure an atmospheric pressure, atmospheric temperature, humidity, etc. Detection signals from the photoelectric sensor 28 and the environmental sensor 29 are used to calculate a change of the image-formation characteristics of the optical projection system PL. Details of the operation will be explained later.

Next, an image-formation characteristic correcting mechanism, including an isotropic distortion correcting mechanism, in this embodiment will be explained. As has been described above, the number of kinds of image-formation characteristics to be corrected tends to increase as the line width of a pattern to be transferred by exposure reduces. Therefore, in this embodiment, examples of correction of the following four different kinds of image-formation characteristics will be shown: (a) isotropic distortion (hereinafter occasionally referred to as simply “distortion”); (b) projection magnification; (c) defocus; and (d) field curvature.

First, the distortion is corrected by driving the distortion corrector 31, which is disposed between the reticle R and the optical projection system PL, to thereby change the optical path length between the reticle R and the optical projection system PL. The optical projection system PL in this embodiment is assumed to be an optical system in which the magnification component does not change with variations of the optical path length regardless of whether or not it is telecentric on the mask side.

The distortion corrector 31 comprises an optical wedge 12 which is closer to the reticle R, and an optical wedge 13 which is disposed to underlie the optical wedge 12. The optical wedges 12 and 13 are wedge-shaped flat glasses of approximately the same size. Each of the optical wedges 12 and 13 has a configuration in which both ends thereof differ in thickness from each other. The upper side of the optical wedge 12 and the lower side of the optical wedge 13 each comprises a plane which is perpendicular to the optical axis IX. The lower side of the optical wedge 12 and the upper side of the optical wedge 13 are parallel to each other and tilted with respect to a plane perpendicular to the optical axis IX, as shown in FIG. 1. The arrangement of the distortion corrector 31 is advantageous in that it does not require very stringent tolerance requirements for the distance between the distortion corrector 31 and the reticle R and for the distance between the distortion corrector 31 and the optical projection system PL. In other words, because the distortion corrector 31 is equivalent to a plane-parallel plate, it has substantially no effect on the projected image unless it is inclined to a considerable extent.

The optical wedges 12 and 13 are secured to respective drive guides (not shown) and capable of being driven in the scanning direction (direction X) indicated by the arrows in FIG. 1. Accordingly, the optical wedges 12 and 13 are driven in the direction X with both the upper side of the optical wedge 12 and the lower side of the optical wedge 13 kept perpendicular to the optical axis IX, but prevented from-moving in-a direction other than the direction X by the guides. The positions of the optical wedges 12 and 13 are measured by respective position sensors, e.g., linear encoders, potentiometers, etc., and the optical wedges 12 and 13 are positioned by respective drive mechanisms comprising motors, etc. in an optical member control system 14 according to desired values set by the main control system 30.

It should be noted that there are no particular restrictions on the size of the optical wedges 12 and 13, the spacing between the optical wedges 12 and 13 and the disposition between the optical wedges 12 and 13 and the reticle R, and the disposition between the optical wedges 12 and 13 and the optical projection system PL. Regarding the size thereof, the optical wedges 12 and 13 should preferably have such a thickness that the optical wedges 12 and 13 will not be bent, and such a weight that they can be readily driven. Regarding the disposition of the optical wedges 12 and 13, however, it is preferable to dispose them near the reticle R in order to minimize the influence on aberrations other than distortion.

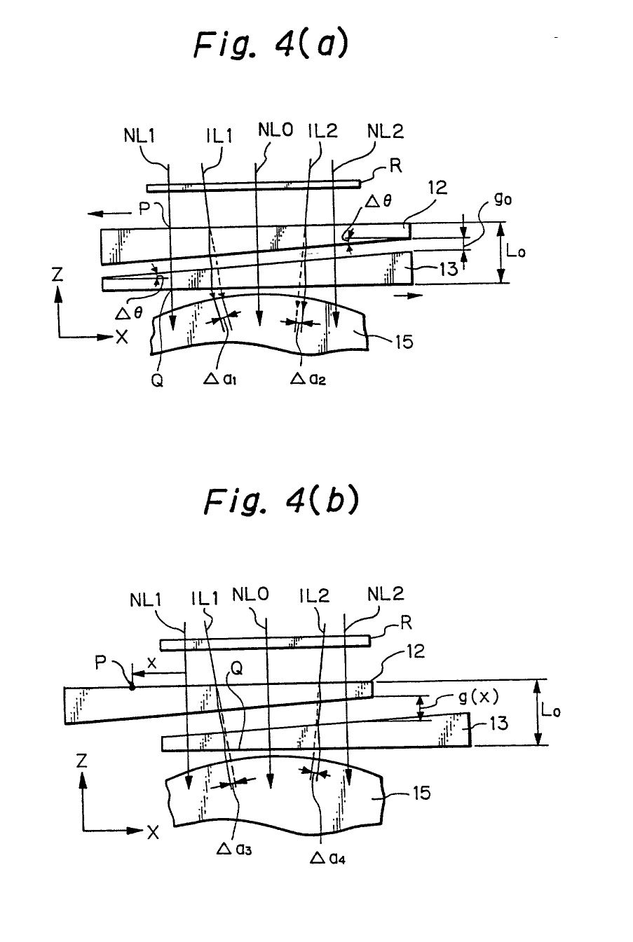

Next, the principle of controlling isotropic distortion by the distortion corrector 31 will be explained in detail with reference to FIGS. 4(a) to 6.

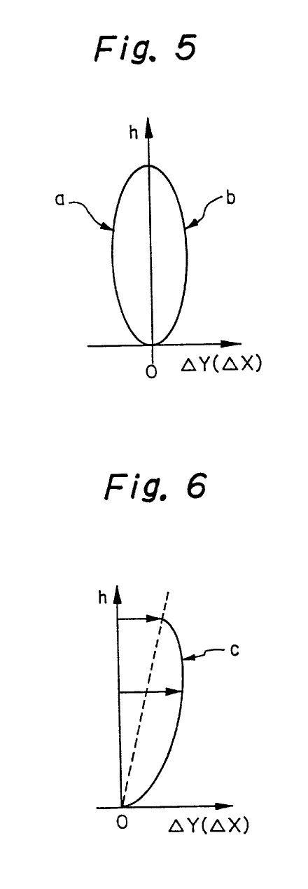

FIGS. 4(a) and 4(b) schematically illustrate the isotropic distortion correcting principle in this embodiment. FIG. 4(a) shows the optical wedges 12 and 13 in a state where they are at the same position in the direction X, and FIG. 4(b) shows the optical wedges 12 and 13 in a state where they have been displaced relative to each other in the directions −X and +X, respectively. FIG. 5 shows one example of isotropic distortion in this embodiment, and FIG. 6 shows one example of a result of actual distortion correction.

Assuming that the optical projection system PL is telecentric on both sides, all principal rays traveling from the reticle R toward the optical projection system PL must be parallel to the optical axis in theory; in practice, however, principal rays between the reticle R and the optical projection system PL are slightly inclined at some image heights due to aberrations (pupil and other aberrations) which cannot be corrected. Some optical projection systems are designed so that magnification variable components effectively cancel each other, although the optical systems are not telecentric on both sides in the strict sense of the term “telecentric”(i.e., having an aperture stop located at the focal point in image space). These optical projection systems, however, are equivalent to those which are telecentric on both sides in terms of the change of distortion. Therefore, the same effect can be obtained with respect to such optical projection systems.

An optical projection system of the type described above is so adjusted that, as shown in FIGS. 4(a) and 4(b), principal rays NL0, NL1 and NL2 which pass through the central and peripheral portions of the effective illumination area (an area which is conjugate to the effective exposure field of the optical projection system) on the pattern surface of the reticle R are approximately parallel to the optical axis IX (see FIG. 3). Therefore, principal rays IL1 and IL2 passing through the left and right intermediate regions of the effective illumination area are usually tilted with respect to the optical axis IX. Accordingly, positions on the uppermost lens 15 of the optical projection system PL at which the principal rays IL1 and IL2 passing through the optical wedges 12 and 13 strike the lens 15 shift outwardly by Δa₁ and Δa₂, respectively. In this case, the principal rays NL0, NL1 and NL2, which are parallel to the optical axis IX, also slightly shift in the direction X. More specifically, the principal rays NL0, NL1 and NL2 shift in the direction X from their initial positions by the same amount according to the inclination angle Δθ of each of the lower and upper sides of the optical wedges 12 and 13 with respect to a horizontal plane and according to the amount of change of the gap (denoted by g(x)) between the lower side of the optical wedge 12 and the upper side of the optical wedge 13. When the inclination angle Δθ and the amount of change of the gap g(x) are small, the amount of shift of the principal rays NL0, NL1 and NL2 is small. However, the shift of the principal rays NL0, NL1 and NL2 causes a change of the base line, which is an amount of offset between the center of the exposure field and the center of detection by an off-axis alignment system, for example. As a result, the alignment accuracy is degraded. Therefore, it is desirable to obtain a gap g(x) from the amount of movement in the direction X of the optical wedges 12 and 13, to obtain an amount of shift of the principal rays NL0, NL1 and NL2 from their initial positions on the basis of the amount of change of the gap g(x) and the inclination angle Δθ, and to correct the base line by the amount of shift of the principal rays NL0, NL1 and NL2. Assuming approximately that the positions of principal rays incident on the uppermost lens 15 of the projection optical system PL shift in the direction X only at the intermediate image height, the following description will be made with respect to only the principal rays IL1 and IL2.

It should be noted that, as will be clear from FIG. 3, the actual illumination area IAR is short in the scanning direction (direction X), and therefore, the amount of distortion produced in the direction X within the illumination area IAR is small, and hence the amount of correction to be made for distortion in the direction X is small. On the other hand, the illumination area IAR is long in the non-scanning direction (direction Y); therefore, the isotropic distortion correcting mechanism in this embodiment is particularly effective for correction of distortion in the non-scanning direction (direction Y). Although the following description is made with respect to the correction of distortion in the direction X, distortion in the direction Y can also be corrected in the same way because the effect is isotropic.

Referring to FIG. 4(a), the optical path length from the upper side of the optical wedge 12 to the lower side of the optical wedge 13 is given by Initial value of optical path length=(L₀-g₀)n+g₀ where n is the refractive index of the optical wedges 12 and 13, and go is the gap between the optical wedges 12 and 13.

Next, the optical wedges 12 and 13 are moved leftward and rightward, respectively, so that the points P and Q in FIG. 4(a) move in the direction X by −x and +x, respectively, as shown in FIG. 4(b). In FIG. 4(b), assuming that the inclination angle Δθ is small, the gap g(x) between the optical wedges 12 and 13 is approximately given by

g(x)=g₀+2x·Δθ

Accordingly, the optical path length from the upper side of the optical wedge 12 to the lower side of the optical wedge 13 is given by

$$\begin{matrix}Optical path length = ( {L}_{0} - g ( x ) ) n + g ( x ) \\ = ( {L}_{0} - {g}_{0} ) n + {g}_{0} - 2 X \cdot Δθ ( n - 1 )\end{matrix}$$

In this case, the refractive index n of the optical wedges 12 and 13 is larger than 1 (e.g., of the order of 1.5). Therefore, it will be understood from the above expression that, in the state of FIG. 4(b), the optical path length for the principal rays IL1 and IL2 is shorter than in the state of FIG. 4(a). Accordingly, the shift quantities Δa₃ and Δa₄ of the principal rays IL1 and IL2 incident on the uppermost lens 15 of the optical projection system PL become smaller than the shift quantities Δa₁ and Δa₂ in FIG. 4(a). Since the above expression of the optical path length is invariant in the XY-plane, the shift quantity of a ray bundle which is away from the optical axis IX in the non-scanning direction (direction Y) changes in a similar manner to the above.

Referring to FIG. 5, the curves a and b represent distortions in the conditions shown in FIGS. 4(a) and 4(b). In FIG. 5, the ordinate axis represents the image height h in the direction Y, that is, a variable corresponding to the position (i.e., the distance in the direction Y from the optical axis) where illuminating light passes at the reticle side, and the abscissa axis represents the distortion ΔY in the direction Y at the corresponding image height h. It should be noted that, since distortion is isotropic, the distortion ΔX in the direction X at the corresponding image height h in the direction X is similar to that shown in FIG. 5. In the case of the illustrated example, the distortions in the directions Y and X of the projected image can be made approximately zero by setting the optical wedges 12 and 13 so that the distortion curve becomes intermediate between the curves a and b in FIG. 5, i.e., that the positions of the optical wedges 12 and 13 are intermediate between those shown in FIGS. 4(a) and 4(b). In general, however, not only distortion but also the magnification component varies; therefore, if the optical wedges 12 and 13 are adjusted so that the distortion curve becomes intermediate between the curves a and b in FIG. 5, the distortion curve changes as shown by the curve c in FIG. 6. That is, there are cases where some magnification error undesirably remains. In this embodiment, however, the magnification component and the distortion component are corrected by respective independent correcting mechanisms. Therefore, correction can be made readily.

Next, mechanisms for correcting the other items to be corrected (i.e., (b) projection magnification, (c) defocus, and (d) field curvature) will be briefly explained. In this embodiment, the projection magnification and the field curvature are corrected by a method in which, among lenses constituting the optical projection system PL, the uppermost lens 15 and the subsequent lens 16 are driven to move in the optical axis direction. Referring to FIG. 1, the upper-most lens 15 is secured to a holder 18, and the lens 16 is secured to a holder 19. The holders 18 and 19 are connected through stretchable drive elements 20 which are circumferentially disposed. Piezoelectric elements, for example, are usable as the drive elements 20. The holder 19 is connected to a lens tube body of the optical projection system PL through drive elements 21. A drive controller 22 drives the drive elements 20 and 21 according to commands issued from the main control system 30. Usually, the amounts of extension and contraction of the drive elements 20 and 21 are feedback-controlled by position sensors (not shown). Movements in the optical axis direction of the uppermost lens 15 and the subsequent lens 16 cause the projection magnification and the field curvature to change, respectively. To obtain desired projection magnification and field curvature characteristics, simultaneous equations of two unknowns for these characteristics are solved to thereby determine amounts of drive for the uppermost lens 15 and the lens 16. To correct defocus, the angle of the plane-parallel glass in the light-receiving optical system 27 of the wafer position detecting system is adjusted, and the wafer W is aligned with respect to a desired position.

As has been described above, distortion correction can be made by adjusting the positions of the optical wedges 12 and 13, and the projection magnification and the field curvature can be corrected by driving the uppermost lens 15 and the subsequent lens 16. In addition, defocus can be corrected by offset adjustment of the light-receiving optical system 27. If defocus resulting from the correction of the distortion, the projection magnification and the field curvature is also corrected by the light-receiving optical system 27, all the image-formation characteristics can be corrected. Regarding the correction of the projection magnification, defocus, and field curvature, various methods have been devised in addition to those used in this embodiment. Any of the methods may be employed if necessary. There are other correction methods, i.e., a method in which the pneumatic pressure in the space between predetermined lenses in the optical projection system PL is varied, and a method in which the wavelength of light emitted from the light source 1 is changed.

The following is a description of the way of determining a desired value for each of the above-described correcting devices, that is, a description of a device for detecting an amount of change of each object to be corrected. Since detecting devices for the objects to be corrected are almost the same, the following description is made with respect to distortion as an example. Typical causes of the change of distortion are as follows: variations in the atmospheric pressure; changes in the illumination conditions; absorption of illuminating light by the optical projection system; and absorption of illuminating light by the reticle. In addition, there is also a case where the distortion of an exposure system which is to be subsequently used is changed so as to be conformable to the distortion of an exposure system already used in the exposure process for forming the previous layer on the wafer when a plurality of exposure apparatuses are mixedly used.

With respect to variations in the atmospheric pressure, a change in the atmospheric pressure is measured by the environmental sensor 29, and the result of the measurement is sent to the main control system 30. Usually, the atmospheric pressure change and the distortion change are in proportional relation to each other. Therefore, an amount of change of the distortion can be calculated from the atmospheric pressure change by using a proportional constant previously determined by an optical simulation, experiment, etc. Similarly, an amount of change of the distortion can be calculated from the atmospheric temperature, humidity, etc. as well.

Regarding changes in the illumination conditions, the optical path in the optical projection system PL for a bundle of light rays from the reticle R differs according to the illumination conditions. Therefore, distortion is produced by the effect of aberration remaining in the optical projection system PL. In this regard, the main control system 30 knows the present illumination conditions by being informed of the position of the turret 3. Therefore, an amount of change of the distortion can be determined from data which has previously been obtained by an experiment, etc. Other conditions which cause a change of the optical path in the optical projection system PL include: the degree of fineness of the pattern on the reticle R; the difference in the angle of diffracted light which is produced according to whether or not a phase shifter is used; the size of the stop (NA stop) at the pupil plane of the optical projection system PL; and whether or not a pupil filter PF is present at the pupil plane. Regarding these conditions also, relationships with the distortion change should previously be obtained. It is also possible to employ a method in which a light intensity distribution in the pupil plane of the optical projection system PL is directly measured. More specifically, the relationship between the light intensity distribution in the pupil plane and the distortion change is previously obtained, and the measured value is compared with the previously obtained relationship to determine an amount of distortion. As a method of measuring a light intensity distribution in the pupil plane, it is possible to use a method in which a sensor is inserted into the pupil plane, or a method in which the stop at the pupil plane is opened or closed according to the amount of light measured in the image plane with a sensor.

Next, to correct distortion due to the absorption of illumination light by the optical projection system PL, the transmittance of the reticle R is measured by the photoelectric sensor 28 on the wafer stage WST, and the light intensity of the light source 1 is measured by the photoelectric sensor 24, thereby determining an amount of light energy incident on the optical projection system PL. Further, an amount of light energy re-entering the optical projection system PL after reflection from the wafer W can be measured with the photoelectric sensor 25. Thus, it is possible to calculate an amount of distortion due to the absorption of illuminating light, provided that the relationship between the incident light energy and the distortion change has been previously obtained by an experiment, for example, and stored in the form of a differential equation.

Regarding the absorption of illuminating light by the reticle, the transmittance of the reticle R, that is, the pattern density on the reticle R, can be measured by the photoelectric sensor 28 on the wafer stage WST, and the intensity of light incident on the reticle R can be measured by the photoelectric sensor 24 in the same way as in the case of the absorption of illuminating light by the optical projection system PL. Absorption of illuminating light by the reticle R occurs in the pattern portion, not in the transmitting portion. Therefore, if the pattern density and the absorbance of the pattern are known, the heat quantity absorbed by the reticle R can be obtained. Since the absorbance of the pattern is determined by the material of the pattern, it should be input in advance. Further, the relationship of the distortion change to the light energy absorbed by the reticle R should previously be obtained by an experiment, for example, and stored in the form of a differential equation in the same way as in the case of the absorption of illuminating light by the optical projection system PL. Thus, it is possible to obtain amounts of distortion due to the above-described various causes: variations in the atmospheric pressure; changes in the illumination conditions; absorption of illuminating light by the optical projection system; and absorption of illuminating light by the reticle. Accordingly, an amount of distortion to be corrected is determined by the sum of amounts of distortion due to the above-described causes.

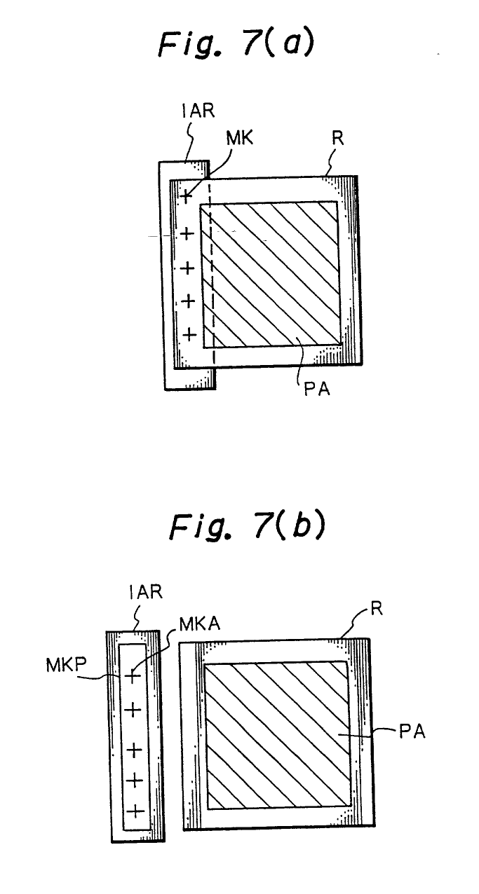

Although in the above-described method the causes of distortion change are measured, and an amount of distortion change is obtained by a calculation, it should be noted that a method of directing measuring distortion is also conceivable. Such a method will be explained below with reference to FIGS. 7(a) and 7(b).

FIG. 7(a) shows marks provided on the reticle R to measure distortion. Referring to FIG. 7(a), a plurality of marks MK for position measurement are previously written outside the pattern area PA on the reticle R to measure distortion directly. In measurement, only the marks MK in the illumination area IAR are illuminated, and the positions of the mark images are measured by a photoelectric sensor provided on the wafer stage WST. As the photoelectric sensor on the wafer stage WST, it is possible to use a two or one-dimensional imaging device, e.g., a CCD. In this case, the positions of the images of the marks MK are measured by image processing using the imaging device. As a method of position measurement using a photoelectric sensor, there is a known method which uses a slit and a light-receiving element for receiving light forming an image of a mark MK through the slit, and in which the relative position of the slit position and the mark position is determined from a signal from the light-receiving element. It should be noted that what is measurable with the marks MK shown in FIG. 7(a) is distortion in the direction Y, but distortion in the direction X can also be measured in the same way. These methods cannot frequently be carried out because a relatively long time is required for measurement. Therefore, an even more effective way of measuring distortion is to use such a direct measuring method in combination with the above-described method by calculation to correct a computational error.

FIG. 7(b) shows an example of a method which uses no marks MK on the reticle R. Marks MK provided on the reticle R involve a position error introduced during writing, and the error differs for each reticle. Therefore, accurate distortion measurement cannot be performed on the basis of such marks MK. For this reason, in the example shown in FIG. 7(b), a mark plate MKP which is provided with a plurality of marks MKA is provided in the neighborhood of the reticle R. The spacing between each pair of adjacent marks MKA should be strictly measured in advance. If the mark plate MKP is provided in an approach area, which is provided in order to scan the reticle R at constant speed during exposure, no extra place is needed.

Thus, an amount of change of distortion is determined, and the positions of the optical wedges 12 and 13 are changed so that the amount of distortion change is canceled.

It should be noted that in this embodiment the distortion and the projection magnification are corrected independently of each other. However, in a case where the optical projection system PL is not completely telecentric on the reticle R side, the movement of the optical wedges 12 and 13 causes the magnification component and the distortion component to change simultaneously. The magnification component and the distortion component are also caused to change simultaneously by driving the lenses 15 and 16 of the optical projection system PL. However, if the ratio of these components differs, the magnification and distortion components can be independently corrected by obtaining optimal drive quantities from simultaneous equations. Accordingly, the method of this embodiment is also applicable to an optical projection system which is not telecentric on both sides.

As has been described above, in the projection exposure apparatus according to this embodiment the distortion corrector 31 comprises a pair of optical wedges 12 and 13 whose thickness in the direction of the optical axis IX is continuously variable, and thus the thickness of a portion of the distortion corrector 31 through which principal rays pass is changed by moving the optical wedges 12 and 13 in a direction perpendicular to the direction of the optical axis IX. In this way, the optical path length between the reticle R and the optical projection system PL can be changed. Further, since the distortion corrector 31 is disposed between the reticle R and the optical projection system PL with no other optical member (lens) interposed therebetween, the system is free from aberrations which would otherwise be produced by such an optical member. Accordingly, aberration which is produced by a change of the optical path length due to the use of the distortion corrector 31 is smaller than aberration produced when the spacing between other optical elements is changed. Thus, isotropic distortion (pincushion distortion or barrel distortion) can be changed independently of other aberrations. Further, this embodiment has the advantage that the optical wedges 12 and 13 can be reduced in size because the optical wedges 12 and 13 are moved in the scanning direction (direction X) and the illumination area IAR of the reticle R is short in the scanning direction.

Further, the method of this embodiment need not physically drive either the reticle R or the optical projection system PL itself, and is therefore free from the degradation of the rigidity of the apparatus even in the case of a scanning type projection exposure apparatus as in this embodiment.

Further, since the distortion corrector 31 uses a pair of optical wedges 12 and 13 each having a continuously variable thickness, the thickness of a portion of the distortion corrector 31 through which illuminating light passes can be continuously changed by moving the optical wedges 12 and 13 in the scanning direction, in which the thickness of the distortion corrector 31 is variable. Accordingly, distortion can be continuously corrected. If the optical wedges 12 and 13 are designed so that the change of the thickness is gentle (i.e., the inclination angle Δθ is small), the thickness of the distortion corrector 31 can be strictly controlled without the need of strictly positioning the optical wedges 12 and 13. Particularly, the distortion corrector 31 comprises a pair of optical wedges 12 and 13 each having a continuously variable thickness, and the upper side of the optical wedge 12 which faces the reticle R and the lower side of the optical wedge 13 which faces the optical projection system PL are planes parallel to each other. Therefore, three-dimensional positioning of the optical wedges 12 and 13 needs no very high accuracy. Accordingly, the positioning accuracy for the optical wedges 12 and 13 is much less strict than that required when the reticle R or the optical projection system PL itself is driven. Thus, it is possible to realize distortion correction at low cost without any deterioration in optical performance.

It should be noted that in a case where the inclination angle Δθ of the optical wedges 12 and 13 is large, and the travel distance in the scanning direction of the optical wedges 12 and 13 is long, the thickness of a portion of the distortion corrector 31 through which the illuminating light IL passes changes to a considerable extent as the optical wedges 12 and 13 move, thus causing spherical aberration to occur. Accordingly, the inclination angle Δθ and the travel distance of the optical wedges 12 and 13 must be set within a range in which no spherical aberration is produced. In this case, spherical aberration may be corrected by providing an optical wedge for spherical aberration correction between the optical projection system PL and the wafer W.

Further, in this embodiment the optical wedges 12 and 13 are driven to move in a direction (direction X) perpendicular to the optical axis IX; in this case, the gap between the optical wedges 12 and 13 changes. If the inclination angle Δθ is large and the gap between the optical wedges 12 and 13 changes to a considerable extent, the lateral displacement of the image increases in excess of the allowable value, as described above. Therefore, it is desirable to provide, for example, a moving mechanism which causes the optical wedges 12 and 13 to move with the gap therebetween kept constant (i.e., the optical wedges 12 and 13 are moved relative to each other substantially along their slant surfaces). Alternatively, it is also possible to determine an amount of lateral displacement of the image by a calculation and add the amount of lateral displacement to the base line as an offset during alignment.

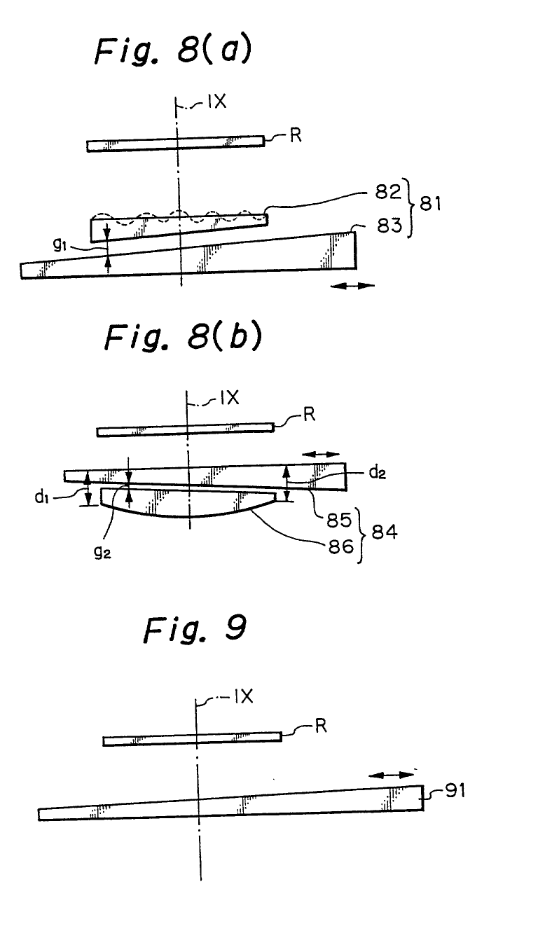

Next, modifications of a distortion corrector used in the projection exposure apparatus according to the present invention will be explained with reference to FIGS. 8(a) to 10. First, a first modification will be explained with reference to FIGS. 8(a) and 8(b). In this modification, only either one of two optical members which correspond to the optical wedges 12 and 13 shown in FIG. 1 is driven.

FIG. 8(a) shows the arrangement of a distortion corrector according to this modification. Referring to FIG. 8(a), a distortion corrector 81 comprises an optical wedge 82 which is closer to the reticle R, and an optical wedge 83 which is closer to the optical projection system PL. The optical wedge 83 is moved relative to the optical wedge 82 fixed. In this modification, the two optical wedges 82 and 83 are not of the same size, but the optical wedge 83 is larger than the optical wedge 82 in order to give a change of the optical path length to principal rays which are symmetrically apart away from the optical axis IX in the same way as in the embodiment shown in FIG. 1. Further, the upper side of the optical wedge 82 and the lower side of the optical wedge 83 comprise planes perpendicular to the optical axis IX in the same way as in the embodiment shown in FIG. 1, and the optical wedge 83 is driven to move in the scanning direction (direction X) by the main control system 30 through the optical member control system 14, thereby changing the gap g₁ between the optical wedges 82 and 83. As a result, the optical path length is changed to correct distortion. The arrangement of the rest of the apparatus is the same as that of the embodiment shown in FIG. 1.

Although the upper side of the optical wedge 82 is a plane perpendicular to the optical axis IX, it should be noted that the optical wedge 82 can be used as a member for correcting an anisotropic irregular distortion by polishing the upper side of the optical wedge 82 into an irregularly corrugated surface, as shown by the dotted line in FIG. 8(a).

Further, as shown in FIG. 8(b), the surface of one optical wedge which faces the optical projection system PL may be formed from a lens having a curvature. Referring to FIG. 8(b), a distortion corrector 84 comprises an optical wedge 85 which faces the reticle R, and an optical member 86 which faces the optical projection system PL. The optical member 86 has a slant upper surface which is parallel to the lower side of the optical wedge 85. The lower side of the optical member 86 which faces the optical projection system PL is formed as a lens having a curvature. In this case, the optical path lengths for principal rays passing through the distortion corrector 84 must be the same; therefore, the optical wedge 85 and the optical member 86 are formed so that the distances d₁ and d₂ between the upper surface of the optical wedge 85 and the left and right end portions of the lower surface of the optical member 86 are equal to each other. In this modification, the optical wedge 85 is moved relative to the fixed optical member 86 to change the gap g₂ between the optical wedge 85 and the optical member 86 and hence the optical path length, thereby correcting distortion.

The distortion correctors shown in FIGS. 8(a) and 8(b) have the advantages that they require only one drive unit, and that the required positioning accuracy is halved, and further that either the optical wedge or the optical member that is not driven can be used for another purpose, although the lengths and travel distances of the optical wedges 83 and 85, which are driven, are larger and longer than in the case of the embodiment shown in FIG. 1.

Next, a second modification of a distortion corrector used in the present invention will be explained with reference to FIG. 9. In this modification, a distortion corrector comprises a single optical wedge.

FIG. 9 shows the arrangement of a distortion corrector according to this modification. Referring to FIG. 9, a distortion corrector 91 comprises a single optical wedge which is relatively long in the scanning direction (direction X). The side of the distortion corrector 91 which faces the optical projection system PL is formed as a surface perpendicular to the optical axis IX, and the reverse side of the distortion corrector 91 which faces the reticle R is formed as a slant surface with a certain inclination angle. The inclination angle needs to be set to such a degree that the difference in thickness in the scanning direction within the illumination area IAR shown in FIG. 3 can be ignored, and that the slant surface has no adverse effect on the image-formation characteristics. This modification has the advantage that the distortion corrector 91 requires only one drive unit, although the travel distance of the distortion corrector 91 is relatively long.

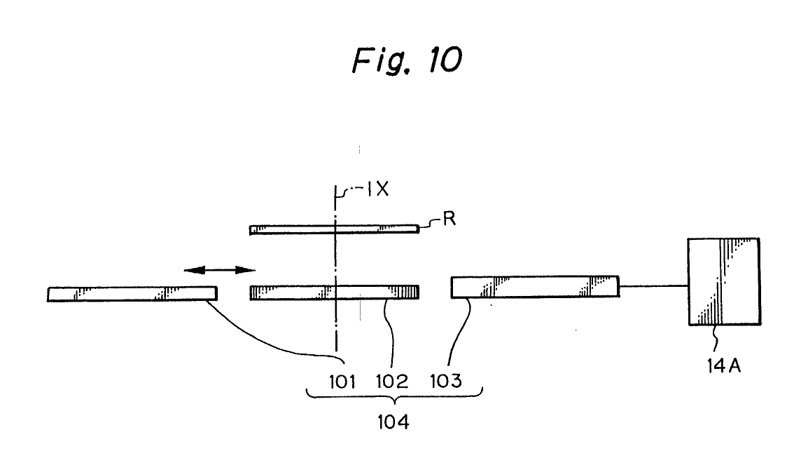

Next, a third modification of a distortion corrector used in the present invention will be explained with reference to FIG. 10. In this modification, no optical wedge is used as a distortion corrector, but distortion is corrected by using a plurality of plane-parallel plates having different thicknesses instead.

FIG. 10 illustrates a distortion corrector according to this modification. Referring to FIG. 10, a distortion corrector 104 comprises three optical members 101 to 103 which are formed from plane-parallel glasses having different thicknesses. The optical members 101 to 103 are changed from one to another according to the need by an optical member control system 14A to change the optical path length, thereby correcting distortion. This modification has the advantage that the total cost is minimized because no surface of an optical member needs to be machined into a slant surface and no particularly high positioning accuracy is required, although distortion cannot continuously be corrected, and the number of optical members required increases.

Although in the above-described embodiment and modifications the present invention is applied to a scanning exposure type projection exposure apparatus, it should be noted that the present invention is also applicable to the correction of isotropic distortion in a one-shot exposure type projection exposure apparatus such as a stepper. In a case where a pair of optical wedges 12 and 13 as shown in FIG. 1 are applied to a one-shot exposure type projection exposure apparatus, it is desirable to set the direction of relative movement of the optical wedges 12 and 13 to a direction parallel to the short side of the rectangular pattern area on the reticle. The reason for this is that, by doing so, the optical wedges 12 and 13 can be reduced in size.

According to the projection exposure apparatus of the present invention, a light-transmitting plate whose thickness in the optical axis direction is variable is disposed between a mask and a substrate, and an optical path length changing device for changing the thickness of the light-transmitting plate is provided. Accordingly, the optical path length between the substrate and the mask can be changed without moving the mask. Therefore, only isotropic distortion can be corrected without degrading the rigidity of the stage that retains the mask. Further, isotropic distortion can be corrected by a simple system arrangement without requiring positioning of high accuracy as is required in a case where the mask is moved in order to correct distortion.

In a case where the light-transmitting plate comprises one or plurality of optical wedges and the optical path length changing device is a device for moving the optical wedge or wedges, distortion can be continuously corrected by a simple moving operation.

In a case where the projection exposure apparatus is a scanning type projection exposure apparatus and the direction of movement of the optical wedge or wedges is the scanning direction, isotropic distortion can be corrected without physically driving the mask itself. Therefore, the present invention is particularly effective for a scanning type projection exposure apparatus which requires high rigidity as a whole. Further, since the width of the illumination area or the exposure area is narrow in the scanning direction, it is possible to reduce the configuration of the optical wedge or wedges and the travel distance thereof.

In a case where the light-transmitting plate comprises a plurality of light-transmitting plates and the optical path length changing device is a device for changing the light-transmitting plates from one to another, the system arrangement is advantageously simplified, although distortion correction is discontinuously made.

It should be noted that the present invention is not necessarily limited to the above-described embodiments, but may adopt various arrangements without departing from the gist of the present invention.

What is claimed is:

1. A projection exposure apparatus comprising:
an illumination system for illuminating a mask with illuminating light;
an optical projection system for projecting an image of a pattern formed on said mask onto a photosensitive substrate; and
a distortion adjusting system having a light-transmitting plate with a variable thickness which is disposed between said mask and said substrate, wherein an optical path length for said illuminating light is varied by changing the thickness of said light-transmitting plate, thereby adjusting distortion of the image of said pattern projected on said substrate.

2. A projection exposure apparatus according to claim 1, further comprising an optical member for correcting spherical aberration.

3. A projection exposure apparatus according to claim 1, wherein said distortion adjusting system has a single optical wedge with a continuously variable thickness as said light-transmitting plate, so that distortion of said projected image is adjusted by moving said optical wedge in a direction in which the thickness of said optical wedge is variable.

4. A projection exposure apparatus according to claim 1, wherein said distortion adjusting system has a plurality of optical wedges each having a continuously variable thickness as said light-transmitting plate, so that distortion of said projected image is adjusted by moving said plurality of optical wedges relative to each other.

5. A projection exposure apparatus according to claim 4, wherein said plurality of optical wedges include a fixed optical wedge and a movable optical wedge.

6. A projection exposure apparatus according to claim 5, wherein said fixed optical wedge has an irregularly corrugated polished surface for correcting anisotropic irregular distortion.

7. A projection exposure apparatus according to claim 5, wherein said fixed optical wedge is a lens having a curvature on one side thereof.

8. A projection exposure apparatus according to claim 1, wherein said distortion adjusting system has a plurality of light-transmitting flat plates having different thicknesses as said light-transmitting plate, so that distortion of said projected image is adjusted by changing said plurality of light-transmitting flat plates from one to another.

9. A projection exposure apparatus according to claim 4, wherein said plurality of optical wedges are moved relative to each other with a gap between mutually opposing surfaces thereof kept constant.

10. A projection exposure apparatus according to claim 4, further comprising a system whereby said plurality of optical wedges are moved relative to each other in parallel to an optical axis, and a lateral displacement of said projected image due to said movement is corrected.

11. A projection exposure apparatus according to claim 1, wherein said distortion adjusting system changes the thickness of said light-transmitting plate according to a degree of fineness of the pattern formed on said mask.

12. A projection exposure apparatus according to claim 1, wherein said distortion adjusting system changes the thickness of said light-transmitting plate according to a density of the pattern formed on said mask and a material of said pattern.

13. A projection exposure apparatus according to claim 12, wherein said mask has a phase shift pattern.

14. A projection exposure apparatus according to claim 1, wherein said distortion is pincushion distortion.

15. A projection exposure apparatus according to claim 1, wherein said distortion is barrel distortion.

16. A scanning type projection exposure apparatus comprising:
an illumination system for illuminating a mask with illuminating light;
an optical projection system for projecting an image of a pattern formed on said mask onto a photosensitive substrate;
a scanning system for synchronously scanning said mask and said photosensitive substrate; and
a distortion adjusting system having an optical member with a thickness continuously variable in a direction of said scanning, wherein distortion of the projected image of said pattern is adjusted by moving said optical member in said scanning direction.

17. A projection exposure apparatus comprising:
an optical projection system for projecting an image of a pattern formed on a mask onto a photosensitive substrate;
an optical member with a variable thickness, said optical member being provided between said mask and said substrate;
a setting system for setting an illumination condition for said mask; and
a distortion adjusting system for adjusting distortion of the projected image of said pattern by changing the thickness of said optical member on the basis of said set illumination condition.

18. A projection exposure apparatus comprising:
an optical projection system for projecting an image of a pattern formed on a mask onto a photosensitive substrate;
an optical member with a variable thickness, said optical member being provided between said mask and said substrate;
an environmental sensor for detecting a change in a use environment of said optical projection system; and
a distortion adjusting system for adjusting distortion of the projected image of said pattern by changing the thickness of said optical member on the basis of said detected change in the environment.

19. A projection exposure apparatus according to claim 18, wherein said environmental sensor includes at least one of a temperature sensor for detecting an ambient temperature of said optical projection system, an atmospheric pressure sensor for detecting an ambient atmospheric pressure of said optical projection system, and a humidity sensor for detecting an ambient humidity of said optical projection system.

20. A projection exposure apparatus comprising:
an optical projection system for projecting an image of a pattern formed on a mask onto a photosensitive substrate;
a distortion adjusting system for adjusting distortion of the projected image of said pattern; and
a correction system for correcting a change in at least either one of a projection magnification and field curvature of said optical projection system due to the adjustment of said distortion.

21. A projection exposure apparatus according to claim 20, wherein said correction system includes a lens moving device for moving a part of a plurality of lenses constituting said optical projection system in a direction of an optical axis of said optical projection system.

22. A projection exposure apparatus according to claim 20, wherein said correction system includes an atmospheric pressure control device for changing an atmospheric pressure in a hermetically sealed space formed between predetermined lenses in said optical projection system.

23. A projection exposure apparatus comprising:
an optical projection system for projecting an image of a pattern formed on a mask onto a photosensitive substrate;
a filtering system for selectively inserting and withdrawing a pupil filter for improving a resolution and focal depth of said optical projection system into and from a pupil plane of said optical projection system; and
a distortion adjusting system for adjusting distortion of the projected image of said pattern according to whether said pupil filter is inserted into or withdrawn from said pupil plane by said filtering system.

24. A projection exposure apparatus comprising:
an optical projection system for projecting an image of a pattern formed on a mask onto a photosensitive substrate;
a distortion adjusting system for adjusting distortion of the projected image of said pattern; and
a correction system for correcting a change in at least either one of a projection magnification and field curvature of said optical projection system due to the adjustment of said distortion.

25. A projection exposure apparatus according to claim 24, further comprising:
a focus detecting system for setting said photosensitive substrate coincident with an image-forming plane of said optical projection system; and
a calibration system for calibrating said focus detecting system in conformity to a change of the image-forming plane of said optical projection system due to the adjustment of said distortion.

26. A projection exposure apparatus according to claim 24, further comprising:
a correction member for correcting spherical aberration of said optical projection system.

27. A projection exposure apparatus comprising:
an optical projection system for projecting an image of a pattern formed on a mask onto a photosensitive substrate;
an optical member with a variable thickness, said optical member being provided between said mask and said substrate;
a measuring device for measuring distortion of the projected image of said pattern; and
a distortion adjusting system for adjusting distortion of the projected image of said pattern by changing the thickness of said optical member on the basis of the distortion measured by said measuring device.
